(19) United States
(12) Patent Application Publication
(10) Pub. No.: US 2003/0007092 A1
(43) Pub. Date: Jan. 9, 2003

(54) Interactive television system

(76) Inventors: Wes Sonner, Campbell, CA (US); Brian Roster, Candia, NH (US); Jim Duval, Shrewsbury, MA (US)

Correspondence Address: J. ROBIN ROHLICEK, J.D., PH.D., Fish & Richardson P.C., 225 Franklin Street, Boston, MA, 02110-2804, US

(21) Appl. No.: 10/128,180

(22) Filed: Apr. 23, 2002

Related U.S. Application Data
(60) Provisional application No. 60/287,198, filed on Apr. 27, 2001.
(60) Provisional application No. 60/296,802, filed on Jun. 8, 2001.

(51) Int. Cl. G06F 3/00; H04N 5/445; G06F 13/00; H04N 7/00; H04N 11/00; G09G 5/00

(52) U.S. Cl. 348/463; 725/37; 345/764; 345/762; 345/700; 348/564

(57) ABSTRACT

A user views television programming while also receiving information related to specific occurrences during live events shortly after they occur. Some of these live events are associated with concurrently available television programming, such as a sporting contest that is associated with live a television program televising the contest. Example of such systems allow users to track progress of live events in which they are interested while viewing television programs that are not necessarily related to those events, and allow the users to directly access more detailed information about the events or television programs related to those events using an interactive interface on the users' television screens.

### CROSS-REFERENCE TO RELATED APPLICATIONS

This application claims the benefit of U.S. Provisional Application No. 60/287,198, filed Apr. 27, 2001, and U.S. Provisional Application No. 60/633,466, filed Nov. 26, 2001, both of which are incorporated herein by reference. This application is also related to U.S. Provisional Application No. 60/296,802 filed Jun. 8, 2001 and to U.S. application Ser. No. 09/377,129 filed Aug. 19, 1999, which are also incorporated herein by reference.

### BACKGROUND

This invention relates to interactive presentation of information in a television system.

Television systems today make use of a variety of approaches to present information related to programming or live events to users (i.e., viewers, customers) of those systems. The information related to programming can include program schedules that allow users to select the programs they view. Information related to live events could include news alerts, sports scores, weather forecasts, and financial quotes.

One approach to presenting the information involves either creating or modifying television programming at a central location, such as at the “head end” of a cable television system. An example of this approach includes creating a television signal devoted to programming information and distributing this television signal to users of a television system over a program guide channel. For example, a user of a cable television system can then tune to the program guide channel and view the information. Another example of centralized creation of television signals includes modifying a television program by incorporating graphical displays of information, such as using a scrolling text display at the bottom of the video frame. Such information might include sports scores of in-progress games for display at the bottom of a presentation of another game so that viewers can track the progress of games they are not viewing.

Another approach to presenting information involves transmitting information to devices that are located at each of the user's premises. In cable and satellite television systems each user generally have equipment, which is commonly known as a “set-top box” or a “digital home communication terminal (DHCT),” that receives signals over the signal distribution systems and provides a function of selecting and decoding television programming for display on the user's television set. The set-top box often also provides access control to programming that may not be accessible to the user using a conventional television tuner.

Today's set-top boxes often include capabilities to generate and display images on a user's television set using information that has been passed to the set-top box as data rather than as a video signal. In some cable television systems, program schedule data is passed from the central location of the cable system to the set-top box. The set-top box includes the capability to generate television signals that present the programming information to the user. This approach enables an interactive user interface in which the user navigates a program guide using a wireless remote control, accesses detailed information about each program, and selects programs to view. In some systems, the user can customize the interface by selecting programming of a particular genre, such as sports programming. The program guide display may co-exist with video programming, for example, in a split screen arrangement in which only a relatively small portion of the television screen is used for the program guide.

Some set-top boxes support a capability to receive emergency messages, such as those in the standard Emergency Alert System, as data and present the alerts on the user's television set independently of the television program being viewed by the user.

Many set-top boxes include programmable processors and semiconductor memory (e.g., RAM) in addition to hardware that is dedicated to decoding and generating television signals. A number of embedded operating systems are now being used in set-top boxes, including PowerTV, OpenTV, and Linux. Some of these operating systems, such as PowerTV, include a software “middleware” layer that provides the capability for an operator of a television system to download software (e.g., an “application”) for execution on the set-top box.

Some cable and satellite television systems support “interactive” modes in which set-top boxes can communicate with the head end and receive customized programming. For example, some systems allow users to order “pay-per view” programming. It is also expected that “video on demand” capabilities will be available to many users in the future using which a user can request programming that is directed to that particular user rather than to a larger population of users. In some cable and satellite systems, communication from the set-top boxes to the head end uses dialed telephone connections. In many current cable television systems, communication from the set-top box to the head end uses radio-frequency communication sharing at least some of the same communication medium (i.e., coaxial cable) that is used for downstream communication from the head end to the set-top box.

Devices that are available today to television users include “personal digital recorders.” Such a recorder includes a magnetic disc memory that is used to record digitized television programming. Currently available recorders include TiVO and ReplayTV. A function of such recorders is that the user can select programs to record for later viewing, functioning essentials as a digital tape recorder. A user can also view a program that is being recorded and can “pause” the viewing while continuing to record the program.

Two-way Internet Protocol (IP) communication is also available over many of today's cable television systems, enabling a user's computer at that user's premises to communicate over the Internet with other computers. At the user's premises a cable modem is attached to the same cable as are the set-top boxes. Downstream communication of IP data uses approaches similar to those used for distribution of television programming, while upstream communication of IP data uses techniques that are similar to those used in interactive cable systems. The functionality of a cable modem can be integrated into a set-top box, which then provides a user with an interface to both television programming and computer communication.

In computer-based rather than television-based systems, users can assess computer servers, for example over the Internet. Many of these servers provide information to the user through interactive interfaces, typically using the content that is formatted as HTML (hyper-text markup language) documents on the servers. Some of these servers provide live information, such as news or sports scores. Compressed video technology, which is often referred to as “streaming video,” is used by some servers to send video signals such as sports highlights over the Internet to a user's computer.

### SUMMARY

In a general aspect of the invention, a user views television programming while also receiving information related to specific occurrences during live events shortly after they occur. Some of these live events are associated with concurrently available television programming, such as a sporting contest that is associated with live a television program televising the contest. Example of such systems allow users to track progress of live events in which they are interested while viewing television programs that are not necessarily related to those events, and allow the users to directly access more detailed information about the events or television programs related to those events using an interactive interface on the users' television screens.

In one aspect, in general, the invention is a method for interactive presentation of information that provides users of a television system with interactive access to live (i.e., in “real time” or with only a short delay) information or television programming that is related to the live information. The invention features an interactive graphical interface on the screen of a television receiver that is controlled by equipment at the user's premises, such as a cable television system “set-top box.” Information is continuously updated in the graphical interface as new information is provided to the user's equipment. The user uses the interactive interface to access more detailed information or to view associated television programming.

Aspects of the invention can include one or more of the following features.

The user's equipment receives a continuous data stream and information in the graphical display is updated as the data changes.

The graphical display occupies a part of the screen and the user can independently select television programming to display in the remaining part of the screen. This feature has the advantage that the user can view live information without having to view a particular television channel. For example, the graphical display can occupy a bottom or side portion of the screen, or both, and the user can view any television program on the remainder of the screen.

The user can select different modes of display in which the graphical interface is not visible, occupies part of the screen, or uses the entire screen.

The user's equipment is configurable to select the particular types of information that are to be displayed. This configuration can be different for different users of the television system. This feature has an advantage of providing the user with information that is most relevant to that user.

The information received by different users' equipment can be the same, while the configuration for different users select different information for display. This has an advantage of not necessarily requiring user-specific information to be sent over the television system while still allowing individual users to view customized displays.

The user can configure the equipment, for example, by using a remote control and programming the equipment directly.

The configuration of the users' equipment can be received from a central location of the television system rather than or in addition to being input directly by each user. This has an advantage of allowing complex configurations that may be difficult for a user to enter to be used.

The user can configure the equipment to display sports information. This has an advantage of providing close to real-time output of information about sporting events that are in progress while the user is viewing television programs other than broadcasts of those events.

The configuration can include a selection of a sports league for which information is to be displayed, and can include particular teams for which game information is to be displayed.

The configuration can include specification of events or “alerts” of which the user is notified through the graphical display. For example, alerts can include changes in data related to particular sports leagues or teams.

The alerts can be displayed in a portion of the graphical display reserved for such alert information.

The user can configure the equipment to specify user-defined conditions under which to change the graphical display for instance by displaying alerts. This feature has an advantage of allowing a user to limit alerts to events that are of most interest to that user.

The user-defined conditions can include definitions of events for which the alerts are to be displayed on the screen.

The user can select more detailed information related to information that is presented on the display. This feature has an advantage of providing an easy-to-use mechanism for the user to access detailed information without necessarily using a large part of the screen display to constantly show the detailed information.

Certain of the displayed information may be associated with concurrent television programming, and such association can be indicated on the graphical display, for instance, using an icon. The user can then select to view a program associated with the displayed information using the graphical interface. This feature has an advantage of providing an efficient program selection capability. For example, a user can select a channel based on viewing a change of data on the graphical display, or based on the display of an alert.

Data received at the customer's equipment is stored for display in a memory in the equipment, such as in semiconductor memory (e.g., RAM).

Data can be repeatedly transmitted to the user's equipment. For example, the television system can retransmit data in a cycle. This has an advantage of not necessarily requiring the user's equipment to store all data that it receives.

The user's equipment can select particular parts of the data it receives to store. For example, this selection may be based on the configuration of the equipment by the user. This feature has an advantage of allowing use of available memory to store data that is most likely to be requested for display by the user.

The user's equipment can include a storage device for television signals, for example a magnetic disk for storing compressed digitized programming.

The user's equipment can then select programs to record based on the data received at the equipment. The user can then later view the portions of the recorded programs.

The graphical display can indicate when displayed data is associated with recorded programming, and the user can then select to view a recorded program. This feature has an advantage of allowing the equipment to record portions of television programs that the user may wish to view. For example, the user's equipment can record programs during periods of time directly after events, such as changes in data (e.g., scores) associated with the events, thereby allowing a user to review “highlights” from those broadcasts.

The user's equipment can select the programming to record based on configuration by the user. This have an advantage of allowing the user to view personalized highlights without necessarily recording programming the user would not be interested in.

The equipment can also receive television signals that specifically include highlights for storing in the user's equipment. Such a highlights television signal can be generated automatically at a central location, either automatically or using an operator's discretion regarding the content of the signal. The availability of the highlights can be indicated on the graphical display and the user can select to view the stored highlights using the interface. This has an advantage of allowing storage of highlights that may not have been detected by the user's equipment. For example, a portion of a sports broadcast leading up to a scoring event can be stored on the user's equipment and made available for the user for viewing.

The equipment can also receive information regarding availability of stored programs at a central location of the television system in which user's equipment can request video programming on-demand. For example, the stored programs can include entire programs, or can include highlight signals that are generated at a central location.

In a system in which stored programs or highlights are made available to the user on demand from a central location of the television system, the graphical interface can indicate the availability of stored programming associated with data that is displayed in the interface. The user can then select the stored programming. The user's equipment then requests that the selected stored programming is sent to the equipment, which then display the selected programming to the user. This feature has an advantage of not requiring the user's equipment to store television programs while allowing the user to request and portions of programs associated with data or alerts displayed on the interface.

The system can include a computer system that receives data from a number of different information and aggregates the data to form a combined data signal.

The combined data signal can be formatted according to structured data format, such as using XML (extensible Markup Language).

The combined signal is then transmitted to a central location of the television system from where the data is sent to multiple users' equipment. For example, the central location of the television system can be a cable system head end, or a central location operated by a multiple system operator (MSO) from where it is sent to multiple separate systems.

The combined signal can be sent to multiple television systems from the computer system that aggregates the data.

The combined data can be sent to the user's equipment using a variety of different communication channels.

The data can be sent encoded “in-band” with a television program. For example, a sports broadcast of a game can include data for that game as well as data for other concurrent games in that league. This approach has an advantage of not requiring the user's equipment to decode programming on multiple channels.

The data can be sent over a dedicated data channel to the user's equipment. This approach has an advantage of allowing any television program to be received and displayed while displaying data that is not necessarily related to that program.

The data can be sent using a data networking protocol that uses a cable television system, for example, using a cable modem integrated in the user's equipment. This approach has an advantage of not requiring a modification of the television system as long as a suitable network server is accessible to the user's equipment.

Other features and advantages of the invention are apparent from the following description, and from the claims.

### DESCRIPTION OF DRAWINGS

FIG. 1 is a block diagram of a system for distributing live information to user terminals;

FIG. 2 is a block diagram of a head end;

FIG. 3 is a block diagram of a home communication terminal;

FIG. 4 is a diagram that illustrates aspects of an interactive user interface; and

FIG. 5 is a block diagram of a home communication terminal that include a video recorder.

### DESCRIPTION

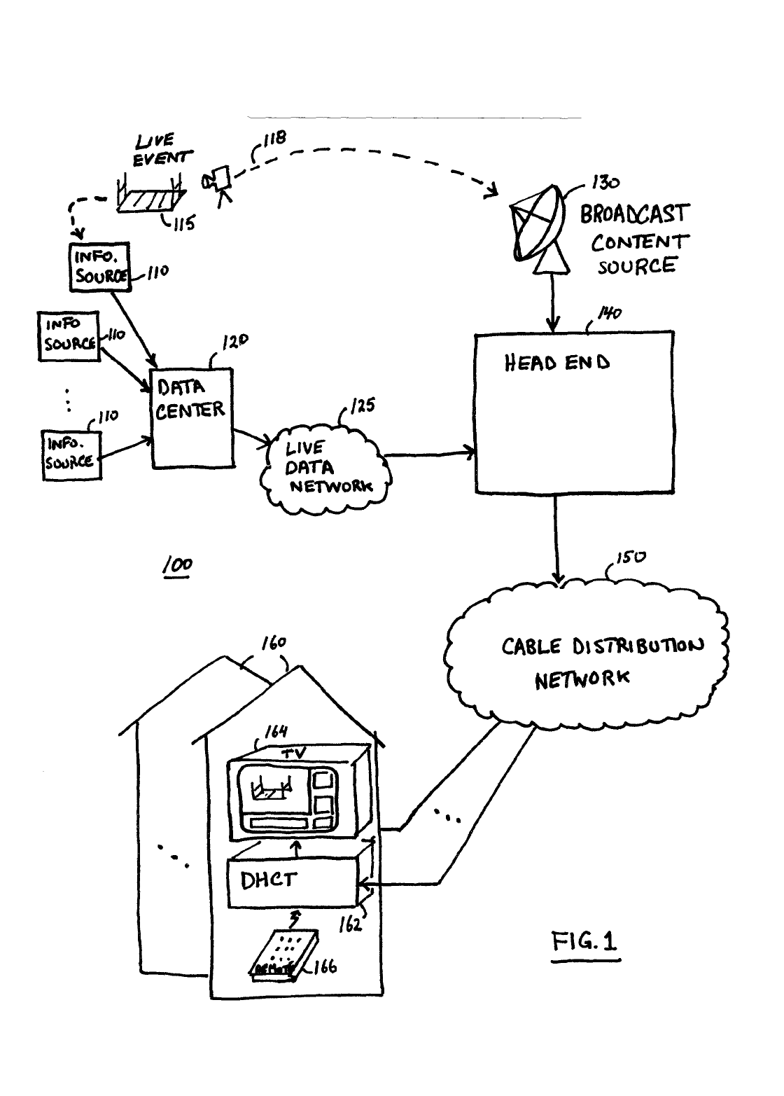

1 System Overview (FIG. 1)

Referring to FIG. 1, a system 100 for distributing live information in conjunction with television programming makes use of elements of a digital cable television distribution system. Broadcast content source 130 provides television signals to a cable system “head end” 140. Head end 140 encodes the television signals in a manner that is appropriate for distribution over a cable distribution network 150. The encoded television signals pass over network 150 to individual users' premises 160, such as residential homes or apartments. At each of the premises, the encoded television signals are passed to a digital home communication terminal (DHCT) 162 that decodes television programming for display on a user's television 164. The user passes commands to DHCT 162 using a wireless remote control 166, which typically uses an infra-red transmission technique. These commands include commands that are used by the DHCT to select which of the available signals are to be decoded and displayed on the television.

In addition to distributing conventional television programming, system 100 also provides a communication path for passing “live” information from information sources 110 to DHCTs 162. Live information includes various types of information such as sports scores, stock prices, weather advisories, and traffic reports. A common aspect of many of these types of information is that its value diminishes as it ages. Therefore, timely delivery of live information to a user is important to preserve the information's value to the user.

Each of a number of separate information sources 110 provides live information to a data center 120. Data center 120 processes the live information it receives from sources 110 and passes this processed information over a live data network 125 to head end 140. The processed information then passes from head end 140 over cable distribution network 150 in conjunction with television programming passing from television sources 130 to the DHCTs. The DHCT 162 at each of the users' premises receives the live information passing from head-end 140 and provides an interactive graphical interface that is selectively displayed on the user's television receiver 164. Various features of this interface are described below. In general, the interface allows the user to access live information that is received at set-top box, and to access television programming that is related to the accessed live information.

As illustrated in FIG. 1, data center 120 provides information over live data network 125 to a single head end 140. Live data network 125 uses encrypted communication paths over the public Internet with both data center 120 and head end 140 having communication links to the Internet. Live data network 125 is alternatively implemented using uni-directional or bi-directional communication approaches such as over leased telephone lines or satellite links.

In general, data center 120 provides the information to a number of head ends. For example, data center 120 may provide the information to a number of separate multiple system operators (MSOs), each of whom passes the information to separate head ends of systems that they operate.

Cable distribution network 150 supports bi-directional communication between DHCTs 162 and head end 140, with significantly higher data rates being available for downstream communication from the head end to the DHCTs than upstream communication from the DHCTs to the head end. Alternative embodiments, some of which do not require bi-directional communication between a head end and a user's set-top box are described below.

In general, at least some of the live information provided by an information source 110 relates to a live event 115. Various types of live events are handled by the system. Sporting contests are used as an illustrative example of live events. Such sporting contests can include football, basketball, hockey, or baseball games. Information related to a live event includes information about specific occurrences in sporting contests such as descriptions of individual plays (a live “play-by-play”), scores, and game or league statistics. Other sports-related live events include automobile races and golf tournaments. Other types of live events include news and weather events, including “breaking” news announcements, news conferences, specific news stories, weather advisories, or live financial information.

A broadcast path 118 from live event 115 to broadcast content source 130 logically represents many stages of preparing and distributing a television program of a live event. As illustrated, a user's DHCT 162 is able to access information related to live event 115 that flows through data center 120, live data network 125, and head end 140 as well as a television program of live event 115 that flows through broadcast content source 130 and head end 140.

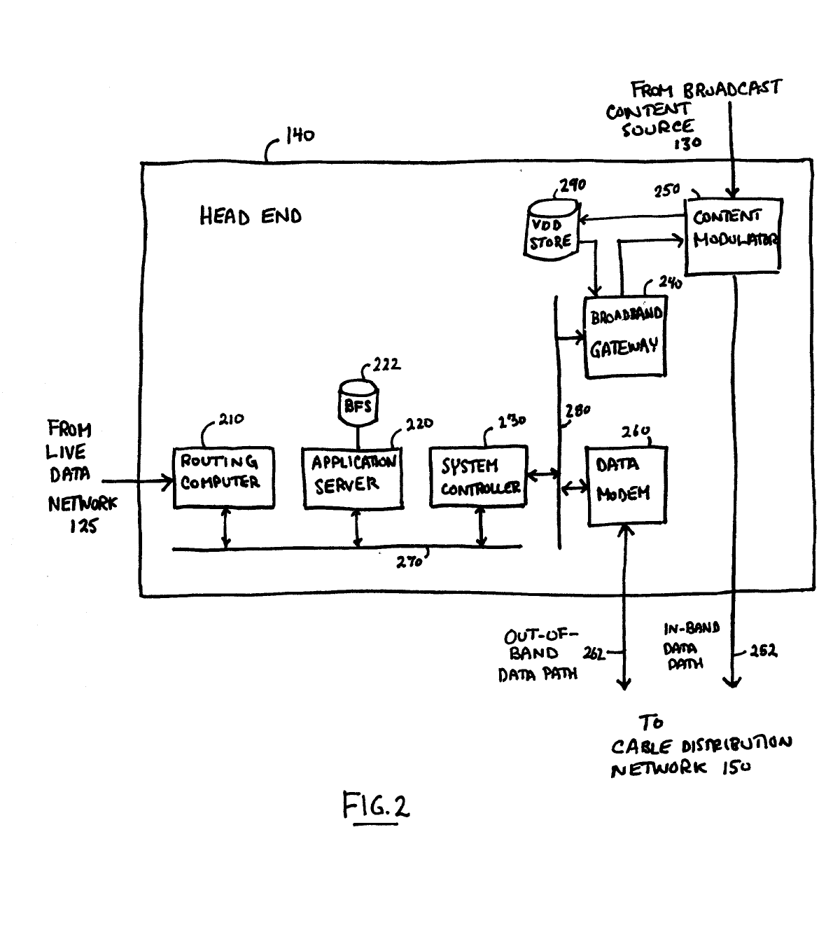

2 Head End 140 (FIG. 2)

Referring to FIG. 2, head end 140 includes a number of interconnected components that together pass information from live data network 125 and television programming from broadcast content source 130 to cable distribution network 150 for transmission to the users' DHCTs.

Head end 140 receives television programs from broadcast content source 130, for instance using one or more satellite receive (downlink) stations. Individual television signals that are received from broadcast data source 130 are passed to a content modulator 250. Content modulator 250 encodes the television signals for transmission in specific frequency bands over cable distribution network 150. At least some of the television programs are transmitted digitally, for example, according to the MPEG-2 standard using a QAM (quadrature amplitude modulation) technique. Typically, content modulator 250 broadcasts the television programming in a number of designated channels, each occupying approximately 6 MHz bandwidth.

Television signals that are transmitted by content modulator 250 using an MPEG-2 format that supports an optional “in-band,” or “private,” data stream. A DHCT that is decoding a television program from a particular channel that is encoded in MPEG-2 format can access the in-band data stream for that program. However, the in-band data streams from other channels would not generally be accessible to a DHCT, as this would essentially require a separate receiver to decode each of those other channels. As discussed further below, an in-band data stream is used to pass live information to the DHCT in alternative embodiments.

In addition to the frequency range used by content modulator 250 for television channels, a data modem 260 uses a separate frequency range to transmit data to the DHCTs. This data is transmitted “out of band” from the television signals and each DHCT includes a separate receiver so that it can receive the data transmitted by data modem 260 independently of which channel transmitted by content modulator 250 it is receiving. In this embodiment, data modem 260 uses a QPSK (quadrature phase shift keying) approach to transmitting a digital data stream using a bandwidth of approximately 1 MHz for the data stream. Data modem 260 is used for various purposes, including transmitting program schedules and emergency alerts to the DHCTs, and may be used to download programs for execution on the DHCTs. Data modem 260 is bi-directional supporting transmission of data to the DHCTs as well as receiving data from the DHCTs. Reverse transmission of data from the DHCTs to the head end use a time-division multiplexing (TDM) approach in which the limited communication capacity is shared by all the DHCTs. The reverse transmission of data includes transmission of control information, such as requests to enable pay-per-view content or to download particular application programs for execution on a DHCT.

Head end 140 optionally includes a broadband gateway 240 that encodes data signals for transmission by content modulator 250 along with television programming in a channel that could be used for transmitting television signals, but is instead devoted to data transmission. Data transmitted through broadband gateway 240 and content modulator 250 generally has a much higher data rate than data transmitted through data modem 260. For example, in some systems, a data rate of 27 Mb/s can be transmitted in one 6 MHz channel. One application of such dedicated data channels is for downstream data communication for Internet Protocol (IP) communication. Head end 140 can provide a gateway to the public Internet and users can connect cable modems to cable distribution network 150. Some DHCT incorporate the functionality of a cable modem using a second receiver such that one receiver is used to receive a television signal while the second receiver is used to receive data. Downstream IP communication passes from the Internet through broadband gateway 240 and content modulator 240 while upstream communication is received through data modem 260. As described further below, live information is alternatively transmitted using IP communication on such a dedicated channel.

Head end 140 includes a system controller 230, which is a computer that communicates with the DHCT over data modem 260, coordinates operation of the head end. Head end 140 includes a local network 280 that couples system controller 230 and data modem 260, as well as a second local area network 270 that couples system controller 230 with a number of other computers that are described below.

A routing computer 210 provides a link in the communication path between live data network 125 and cable distribution network 150. Routing computer 210 passes the information it receives over local network 270 to system controller 230, which combines the information with other data destined for the DHCT and passes the combined data to data modem 260. Live information is formatted as “PassThru” messages, which indicate that the messages should be passed to the DHCT immediately rather than being buffered for significantly later delivery. Each of these messages indicates that it is of a type associated with live information from the live data network. Because the communication capacity of the out-of-band data path 262 is limited, routing computer 210 limits the rate at which it sends data to system controller 230.

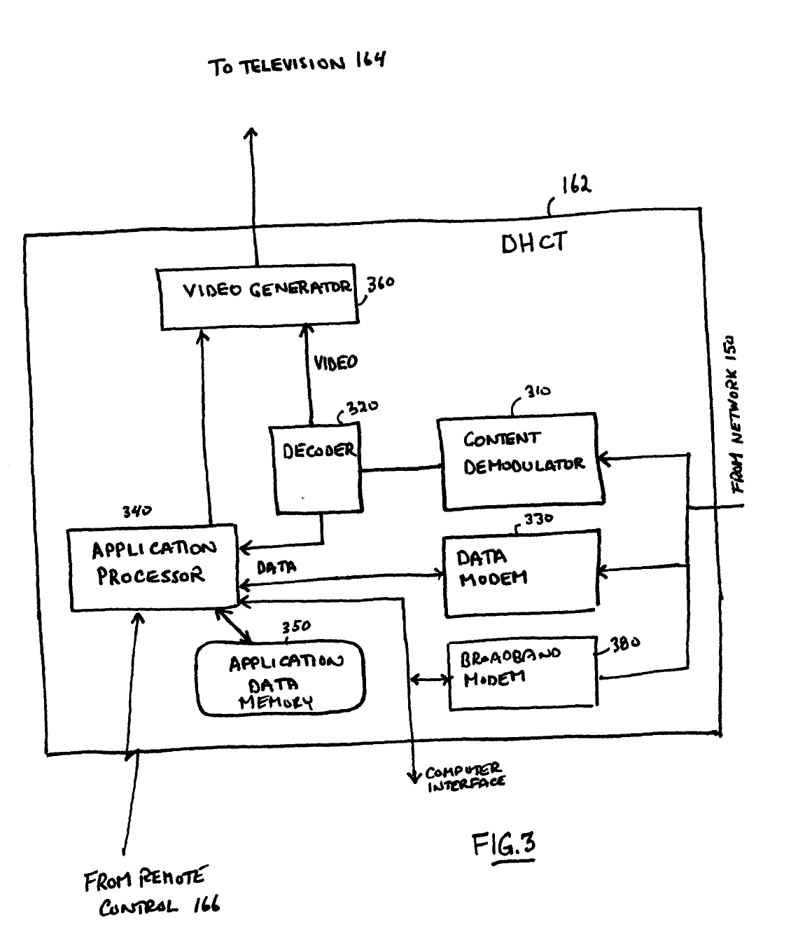

3 DHCT 162 (FIG. 3)

Referring to FIG. 3, DHCT 162 includes an application processor 340, which typically is implemented using a general purpose computer processor, and application data memory 350, which is typically semiconductor memory. The DHCT executes software (e.g., an embedded operating system and application hosted by that operating system) that control operation of the DHCT and that communicate with the head end. One example of a DHCT uses an embedded software operating system, such as PowerTV. An operating system (“kernel”) executing in the DHCT allows applications to be downloaded from application server 220 at head end 140 (see FIG. 2) to the DHCT and executed on the HDCT. One such application is responsible for receiving the live information from the head-end and controlling the graphical interface is downloaded and executes in the DHCT.

DHCT 162 includes a data modem 330, which communicates with data modem 260 at head end 140 (see FIG. 2). In this embodiment, live data is received over data modem 330 and passed to application processor 340.

DHCT 162 includes a content demodulator 310 that receives signals from content modulator 250 at head end 140 (see FIG. 2). Content demodulator 310 selects a particular channel and passes that channel to a decoder 320, which extracts the video signal for the selected television program, which it passes to a video generator 360. Decoder 320 also extracts any private data that is encoded in the selected channel and provides it to application processor 340. In alternative embodiments in which live data is passed in-band with a television signal, the live data passes from decoder 320 to application processor 340.

4 Information Sources 110 and Data Center 120

Referring back to FIG. 1, data center 120 aggregates the information that is receives from various of information sources 110 and forms a data signal encoding the aggregated information for transmission to head end 140 over live data network 125. Data center 120 encodes the data according to a structured data format using an XML (extensible Markup Language) format. At head end 140, routing computer 210 (see FIG. 2) receives the aggregated signal and processes and encodes the signal for transmission to the users. The data is maintained in the XML format for transmission from routing computer 210 to the DHCT 162.

Information sources 110 pass information that includes descriptions of particular occurrences in live events that are associated with those sources. In the case of a live event that is a sporting contest, the information source may provide an encoding of each play of a game. In one example of such an information source, an operator uses a keyboard to annotate discrete occurrences during the live event as they occur. For example, the information source can include a computer executing the @Game software application, which is available from XstreamSports Inc. The discrete occurrences are then encoded using a standard syntax that allows detection of occurrences in the data stream that information source 110 passes to data center 120. For example, for a sporting contest, the operator encodes occurrences such as scores, beginning and ends of plays in sports with discrete plays such as football, and changes of possession for sports with continuous play such as basketball. For each of these occurrences, the operator can also include information characterizing the occurrence, such as an identification of players involved in the event, the type of play, or the position on the field of the play. In another example of an information source, live information related to sporting events are encoded using standard data formats such as Stats Inc. or SportsTicker Sportswire®.

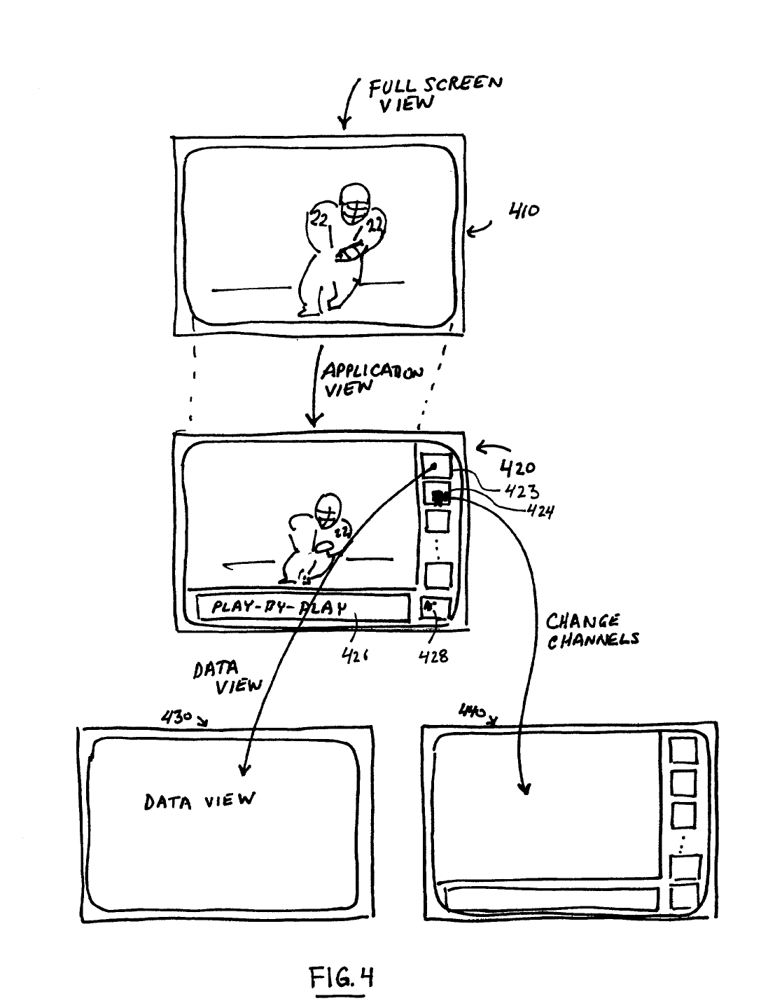

5 Interactive Application (FIG. 4)

DHCT 162 hosts an application that allows a user to access live information that is transmitted from information sources 110 to the DHCT. This application is downloaded from head end 140 when the user activates the application, or alternatively is permanently resident in the DHCT.

Referring to FIG. 4, in one example of such an application, in a first mode, the application does not display a graphical interface on the television screen (screen 410). In another mode, the interface occupies the side and bottom portions of the screen (screen 420). For example, the user can command the DHCT to display the interface and the current television program is reduced in size to occupy the upper left portion of the screen while the interface is shown on the right side and on the bottom.

In this example, the visible interface includes a number of sections or blocks. A first block 423 includes information about a sports league the user has selected. A number of blocks 424 include information about particular games, for example showing their current scores. As the application receives live information related to the displayed league or games, the information in the blocks is updated.

Another block 428 is used for “alerts.” Alerts are notifications of particular occurrences in live events that the user is not monitoring. For example, a change in the score in a game that does not have a block 423 on the display can be displayed as an alert. The application is configured with a number of classes of occurrences that trigger display of alerts in block 428. In this way, the user can be informed of occurrences of interest without necessarily viewing a continuous display of occurrences from those events. In alternative embodiments, such alerts can “pop up” in other portions of the screen, and may be configured to automatically change the television program being displayed.

Another block 426 displays “play by play” information, which can be configured to be associated with the television program being viewed in the main screen or can be associated with another event that is not being viewed.

The user can configure the application to customize the interface to that user. For example, the user can select which league and which games should be displayed in the various blocks of the interface and the classes of occurrences that generate alerts. Examples of occurrences that can trigger alerts include scores, and beginnings and ends of periods of play. Some of this configurations information can be downloaded from the head-end, for example, as part of a preprogrammed information interface.

Copending U.S. Application No. 60/296,802 describes an approach to automatically generating layouts of television programs based on occurrences of preprogrammed events. Such an approach is optionally used to generate parts of the interface display at the DHCT. In such an approach, the definitions of the occurrences and the associated layouts or “rotations” of sequences of layout are downloaded to the DHCT and the application executing on the DHCT detects the occurrences and generates the associated layouts.

The user interface allows the user to obtain more detailed information than is continuously displayed. For example, by selecting the league block 423, a full-screen data view (screen 430) is shown in which more detailed information about the league is available. Similarly, more detailed information related to the other blocks can be accessed in this way. For example, the play-by-play text leading up to the current time can be displayed to allow the user to review the recent history of a game.

In some instances, a block of displayed data is associated with a concurrent television program that is not being displayed. In such a case, a television camera icon is displayed with the data. If the user selects the icon, then the DHCT is tuned to the channel on which the program is being broadcast. This permits a user who sees that a score has occurred in a game of interest to tune to that game by selecting the icon in the block showing the score.

6 Alternatives

6.1 Data Rate Control

Routing computer 210 alternatively limits the rate at which love information is sent to the DHCTs by discarding some of the information that it receives from live data network 125 when there is an insufficient capacity to send it to the DHCTs. The capacity can be constant and statically configured in routing computer 210. System controller 230 alternatively sends messages to routing computer 210 to inform it of the allowable data rate. The allowable data rate may vary over time, and then the system controller 230 informs routing computer 210 of the changes or implements some sort of flow or rate control protocol to enforce the allowable rate.

6.2 In-Band Delivery

In alternative embodiment, live information from routing computer 210 passes to the DHCT via broadband gateway 240 and content modulator 250 rather than through data modem 260. Such data is passed as private data in an MPEG-2 data stream that encodes a television program that is received from broadcast data source 130. In such embodiments, various alternative approaches to receiving the data signal can be used by the DHCT 162. In one such approach the information from live data network 125 is transmitted on multiple channels, such as on a selected subset of channels or even on all channels, thereby allowing DHCT 162 that is decoding one of those channels to receive the live information as well. In another approach, the DHCT includes another tuner that it uses to access the private data in another channel than it is decoding for presenting a television program.

6.3 Broadband Channel

In another embodiment, live information is sent over a channel that is devoted to data transmission, for example, over a channel that provides IP communication between the user's premises and the Internet. When the live data is sent over the dedicated channel, the receiving DHCT 162 can have a separate receiver for that data channel and implements a cable modem within the DHCT to demodulate the live data.

DHCT 162 optionally includes a broadband modem 380, which receives downstream data that is sent through broadband gateway 240 and content modulator 250 at head end 140 (see FIG. 2) and provides a computer interface for IP-based data communication. In alternative embodiments that pass live information through content modulator 250 over a dedicated data channel, broadband modem 380 passes the live information to application processor 340.

6.4 Broadcast File System

In some embodiments of embodiments of the system, head end 140 also includes an application server 220. One function of application server 220 is to maintain a broadcast file system (BFS) 222. Application data that is stored on BFS 222 is continually broadcast to the DHCT using data modem 260 or alternatively using broadband gateway 240 and content modulator 250. The DHCT can then selectively copy data that they need as it is broadcast thereby not requiring the DHCT to maintain a copy of all of the data in the BFS. One example of application data is a program schedule, which is broadcast to the DHCT. It can take many minutes for an update to the BFS to be reflected in the data at the DHCT due to the latency caused by the cycling through the data. In some embodiments of the system, head end 140 also includes a storage 290 for “video on demand (VOD)”. Such programming is transmitted from the head end to particular DHCT using a dynamic allocation of channels in content modulator 250.

In other examples of the system, such an application may be resident in the DHCT, for example, stored in a read-only memory (ROM). The application software may include machine level instructions that are executed on application processor 340, instructions in a higher level language that are interpreted at runtime, or instructions for a virtual machine that are emulated at runtime, or a combination of multiple of such types of instructions.

6.5 Video/Highlights on Demand

A second embodiment of the system includes a “video on demand” capability. In this embodiment, head end 140 records television programs received from broadcast content source 130 on VOD store 290. For example, the head end may be configured to record certain television broadcasts, such as broadcasts of particular sports events. Optionally, these recordings may be deleted after the event is over or at a predetermined time to conserve storage.

Live information that is received from routing computer includes timing information that can be used to identify particular portions of the recorded television broadcasts. For example, each occurrence that is encoded in the live information that is sent to the DHCT includes a time stamp. When the live information identifies occurrences in events for which television broadcasts are stored in VOD store 290, an icon or other indicator on the user interface identifies that the television signal is available for viewing. The user can then select to view a recorded portion of the broadcast. The DHCT sends a command using data modem 330 to system controller 230 at head end 140, which causes a portion of the recorded television broadcast to be sent from VOD store 290 to content modulator 250 and transmitted over a private channel to the requesting DHCT, which decodes the broadcast and displays it to the user.

Various examples of user interface applications allow the user to select particular portions of a recorded event. For example, the user can view a text display of a sequence of occurrences, such as a play-by-play of a sports contest, and select to view the broadcast based on a selected range of occurrences. In such an application, each occurrence is time stamped and these time stamps are transmitted to the DHCT with the live information. When a DHCT requests a particular portion of a recorded broadcast to be transmitted on demand, it passes the starting and ending timestamps to the head end. The system controller at the head end uses these timestamps to determine which portion of the stored broadcast to transmit. In alternative embodiments, identifiers, sequence numbers or tags are transmitted to the DHCT instead of time stamps and are used to select the desired portion of the stored broadcast.

In alternative embodiments, the stored television broadcast may be specially composed for on-demand viewing. For example, a special “highlights” broadcast may include recorded portions of events that are not necessarily broadcast to all the DHCT but are available for on-demand viewing. Similarly, the recorded television signals may include alternative viewing angles, background material, or other associated programming that is available on demand to the user.

U.S. patent application Ser. No. 09/377,129 describes a number of techniques for automatically synchronizing video or television programming with annotations of occurrences within that programming. In some embodiments, such synchronization approaches are used to associate particular portions of the live information with the stored television programming. This synchronization may be performed at the head end, or alternatively may be performed at a central location such as at the data center.

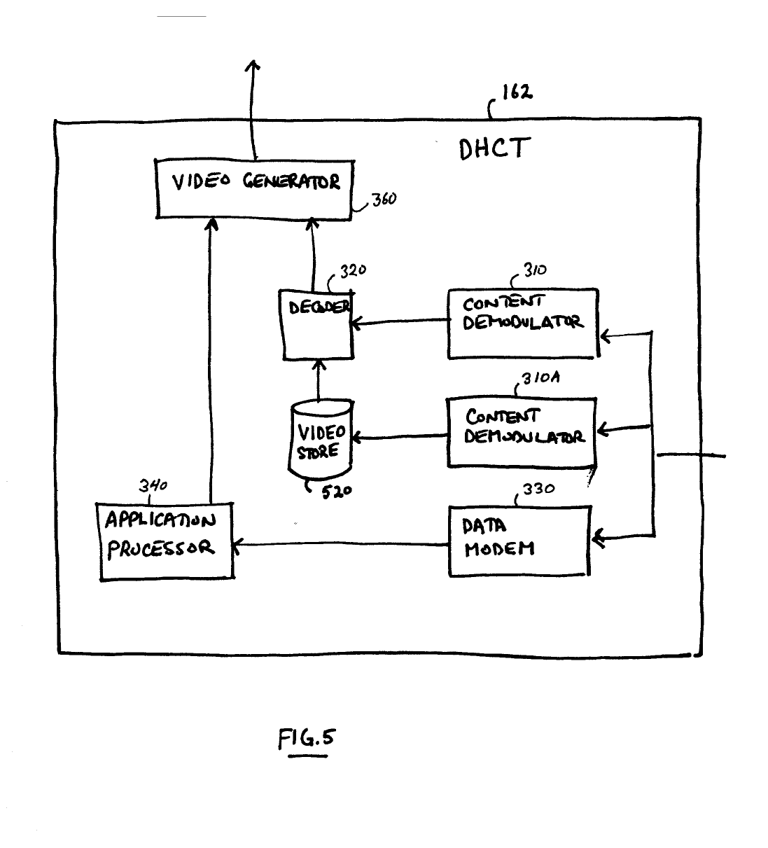

6.6 DHCT Recorded Content (FIG. 5)

Referring to FIG. 5, in another embodiment the DHCT includes a personal digital recorder, which includes a second content demodulator 310A and video storage 520, such as a magnetic disk, for recorded television broadcasts that are received using the second demodulator. In this embodiment, a second television broadcast is recorded on the DHCT and the user can then access the recorded broadcast to view recent events in a broadcast that the user was not viewing. This embodiment provides similar functionality as when television programs are stored and provided in a video-on-demand mode. However, a separate demodulator is needed for each concurrent broadcast being recorded while in the VOD approach, multiple broadcasts may be available. As specially composed “highlights” broadcast can be recorded using the DHCT's recorder to provide limited amounts of a number of different broadcasts. This embodiment provides some access to other broadcasts without needing the system to support full video-on-demand functionality.

6.7 Unidirectional Systems

Some embodiments of the system do not require bi-directional communication between the head end and the DHCT. For example, live information can be distributed over a satellite television system with no upstream communication path while still providing the user with access to live information and an ability to tune to concurrent television broadcasts. Furthermore, embodiments that implement a digital recorder function in the DHCT are compatible with a uni-directional communication system.

6.8 Other Data Distribution Approaches

In embodiments described above, live information is passed from data center 120 to the DHCT 162 over the same cable distribution network that television programming is sent to the DHCT. In alternative embodiments, the live information may be transmitted from the data center to the DHCT over a separate network, such as over a telephone connection, or a data network connection that is separate from the cable network (e.g., an ADSL connection). Similarly, in embodiments in which television programming is distributed to the users by satellite, the live information can be passed to the users over telephone or data network connection.

In embodiments that support video-on-demand aspects for presenting highlights or other recorded programming to a user from the head end, this on-demand programming can also be passed to the user's DHCT over a separate network. For example, on-demand portions of television programs can be passed over an ADSL connection, or as streaming video over a data network connection, while television broadcasts are transmitted over a cable television network or by satellite to the DHCT.

6.9 Client-Server Architecture

In embodiments described above, all or most of the functionality of the user interface is controlled by the application that is executing on the DHCT. In alternative embodiments, the functionality can be split in a client-server architecture in which some or all of the functionality is hosted on a central computer and the remainder, if any, is hosted on the DHCT.

6.10 Other Alternatives

In the description above of components of a DHCT 162, various of the modules may be implemented using dedicated hardware, as software that is executed on a general purpose processor, or using a combination of both.

Application processor 340 can also receive commands from remote control 166, for example, through an infra-red receiver (not shown) in the DHCT.

Routing computer 210 may perform a reformatting function, for example compressing the data for transmission, and may perform error checking on the data.

The live information is sent from information sources 110 to data center 120 over various types of communication links including public or private data networks, or lease communication lines.

It is to be understood that the foregoing description is intended to illustrate and not to limit the scope of the invention, which is defined by the scope of the appended claims. Other embodiments are within the scope of the following claims.

What is claimed is:

1. A method for interactive presentation of information comprising:
providing an interactive graphical interface for displaying information in conjunction with video programming;
continuously updating live information in the graphical interface;
receiving a user input; and
in response to the received input displaying more detailed information using the graphical interface.

2. The method of claim 1 wherein displaying more detailed information includes displaying textual information.

3. The method of claim 1 wherein displaying more detailed information includes displaying video.

4. The method of claim 1 further comprising receiving a continuous data stream and wherein updating the live information uses the received data stream.

5. The method of claim 1 wherein providing the interactive graphical interface includes displaying said interface on a part of a screen and independently displaying video programming in the remaining part of the screen.

6. The method of claim 1 wherein providing the interactive graphical interface includes enabling a user to select different modes of display of said interface.

7. The method of claim 6 wherein the different modes include a mode in which the graphical interface is not visible, a mode in which the graphical interface occupies part of the screen, and a mode in which the graphical interface uses the entire screen.

8. The method of claim 1 wherein providing the graphical interface includes selecting types of information for display.

9. The method of claim 8 wherein selecting the types of information includes selecting sports information.

10. The method of claim 9 wherein selecting sports information includes selecting a sports league for which information is to be displayed.

11. The method of claim 9 wherein selecting sports information includes selecting sports teams for which game information is to be displayed.

12. The method of claim 8 wherein selecting types of information for display include specifying events for notification through the graphical display.
